(19) United States
(12) Patent Application Publication
(10) Pub. No.: US 2025/0326387 A1
(43) Pub. Date: Oct. 23, 2025

(54) BRAKE CONTROL UNIT HAVING REDUNDANT POWER SUPPLY

(71) Applicant: Continental Automotive Technologies GmbH, Hannover (DE)

(72) Inventors: Andreas Kohl, Mainz (DE); Rüdiger Puff, Hünstetten-Wallbach (DE); Achim Netz, Rodgau (DE); Rainer Kohr, Grävenwiesbach (DE)

(73) Assignee: Continental Automotive Technologies GmbH, Hannover (DE)

(21) Appl. No.: 19/183,023

(22) Filed: Apr. 18, 2025

(30) Foreign Application Priority Data
Apr. 18, 2024 (DE) 10 2024 203 626.9

(51) Int. Cl. B60T 17/22

(52) U.S. Cl. CPC B60T 17/221; B60T 2270/402; B60T 2270/414; B60T 2270/415

(57) ABSTRACT

The present embodiments relate to a brake control unit and a method for operating a motor vehicle brake using such a brake control unit. A brake control unit comprises at least one printed circuit board having an electronic circuit arrangement. A first set of electrical power supply connections of at least of a first type and second type are associated with a first vehicle electrical system and form a first power supply path. A second set of electrical power supply connections of at least of a first type and second type are associated with a second vehicle electrical system and form a second power supply path. A common output power supply connection is formed from outputs of the polarity reversal protection circuit for each power supply path brought together at a connection node at which a supply voltage can be provided in operation.

### TECHNICAL FIELD

The present embodiments relate in general to a brake control unit having redundant power supply and a method for operating a motor vehicle brake using such a brake control unit.

### BACKGROUND

Electrically actuable motor vehicle brakes, also referred to as electromechanical motor vehicle brakes (“EMBs”), are increasingly being used as brake systems for motor vehicles. These motor vehicle brakes differ from conventional, hydraulically actuable wheel brakes. For example, there is no longer any need for a complex hydraulics system, and an electromechanical wheel brake also takes up significantly less space.

Electromechanical wheel brakes of this kind typically have an electric or electronic drive unit, which interacts with a mechanism or a transmission. A braking unit can then be arranged on the output side, and this can comprise a brake part having a friction lining, which can be pressed onto a brake disk or drum by means of a translational movement. It is thereby possible to bring about deceleration during operation.

Here, the electric drive unit can comprise an electrically driven motor, also referred to hereinafter as an actuator. The actuation or control of the actuators has great importance in the operation of such an electromechanically actuable motor vehicle brake, since—in contrast to hydraulically actuable wheel brakes, for example—feedback to a driver no longer takes place, for example.

In this case, the associated functions for actuating or controlling the actuators are typically stored in an associated brake control unit. Here, it is possible, for example, to provide a force controller which, on the basis of a specified setpoint force, which can correspond to a driver braking requirement, can generate a setpoint value for the actuator speed or rotation rate in order to apply a brake application force to an associated wheel brake.

The availability of the brake control unit is therefore important, since the wheel brakes are among the safety-relevant functions of the motor vehicle. This can result in a redundant design of essential components or functions. In this sense, redundancy means the additional provision of functionally identical or comparable components, parts, or systems, thus, for example, at least the double provision of connections, for example, data lines, or also at least the double provision of corresponding control units. In this way, a safe operation of the brake system as a whole can still be ensured in the event of failure of a component, a part, or a system. Regardless of this, it is the case that certain functions, for example, auxiliary functions which are used for comfort, can also be omitted in the redundancy level and only the basic functions can be reproduced identically or comparably. In this way, in the event of failure of the brake system, the vehicle is nonetheless to be able to be reliably brought to a standstill and kept there. The requirements for systems of highly automated driving can be higher in this case than for current systems.

It is also to be taken into consideration here that, for example, a failure of the power supply or of the vehicle electrical system can make actuating such a motor vehicle brake no longer possible.

On the other hand, the expenditure for the required redundancy is not to be excessively high, however.

### SUMMARY

This object is achieved by a brake control unit, for example for operating a motor vehicle brake of a motor vehicle, and a method for operating a motor vehicle brake of a motor vehicle.

A first aspect relates to a brake control unit, for example for operating a motor vehicle brake of a motor vehicle, comprising:
at least one printed circuit board having an electronic circuit arrangement,
at least one first set of electrical power supply connections at least of a first type (KL 30_1) and second type (KL 31_1), which are associated with a first vehicle electrical system and form a first power supply path,
at least one second set of electrical power supply connections at least of a first type (KL 30_2) and second type (KL 31_2), which are associated with a second vehicle electrical system and form a second power supply path,
at least one connection for a reference potential, which is associated with the first power supply path, and
at least one connection for a reference potential, which is associated with the second power supply path,
wherein a polarity reversal protection circuit is provided for each power supply path, and
wherein the outputs of the polarity reversal protection circuit are brought together at a connection node and form a common output power supply connection, at which a supply voltage (KL 30_1/2) can be provided in operation.

The embodiments make use of the concept that a redundant vehicle electrical system can often be available in modern motor vehicles. A power supply provided twice, which is therefore redundant, can increase the reliability and availability, which is to be used for the brake control unit. It is assumed hereinafter for simplification that the vehicle electrical system voltage is equal in both vehicle electrical systems. It is also possible to use vehicle electrical systems having different vehicle electrical system voltage. In addition, corresponding means for transformation can be provided to standardize the vehicle electrical system voltage.

It may be provided that the at least two vehicle electrical systems are to be connected directly to the brake control unit or to a printed circuit board of the brake control unit. One aspect can accordingly be considered that of concentrating all required parts and/or functionalities for power supply of a brake control unit from two separate vehicle electrical systems on a single printed circuit board, in order in this way to be able to provide a redundant supply of these safety-relevant electronics without having to provide further or separate additional electronic components having corresponding supplementary functions.

In other words, since the functions of the brake control unit are substantially determined by the availability of an adequate external power supply and a redundant vehicle electrical system is often available, it may be provided that the two vehicle electrical systems can be internally connected directly to a printed circuit board of the brake control unit. According to one embodiment, malfunctions, for example, of a part of one of the vehicle electrical systems or even a failure of one of the vehicle electrical systems, can be recognized here, upon which a switch to the remaining functioning power supply of the other vehicle electrical system can take place. The switch can take place here by way of corresponding functions, which can be implemented in the form of circuit arrangements or corresponding electronic parts on the printed circuit board.

The combination of electronic circuits or associated assemblies or electronic parts to form specific functions is also referred to hereinafter for simplification as a module or function block. The brake control unit can accordingly comprise various functions which are implemented by corresponding circuit arrangements and can be combined to form functional assemblies or modules. Thus, for example, for the brake control unit, one functional assembly can be provided for actuating a service brake and a further functional assembly can be provided for actuating a parking brake. The functions can also be combined, for example, in one or also in multiple ICs or ASICs.

A brake control unit may be provided, which a printed circuit board of the brake control unit may be used to implement the required electronic circuit arrangements for the additional functions of the brake control unit. Accordingly, the printed circuit board can comprise at least one circuit arrangement which is configured to provide the output supply voltage at the output supply voltage connection.

The printed circuit board may comprise for this purpose at least one first set of electrical power supply connections at least of a first type (KL 30_1) and second type (KL 31_1), which are associated with the first vehicle electrical system, and at least one second set of electrical power supply connections at least of a first type (KL 30_2) and second type (KL 31_2), which are associated with the second vehicle electrical system. These power supply connections can be led outward, so that the printed circuit board comprises connection options for direct connection to two separate vehicle electrical systems of the motor vehicle. These power supply connections accordingly represent the input terminals.

Furthermore, at least one connection for a reference potential (“GND”) can be provided for the power supply connections. For example, the two power supply connections of the second type (KL 31_1, KL 31_2) can be electrically connected to the reference potential. The two power supply connections of the second type (KL 31_1, KL 31_2) or the negative terminals can be connected to one another here and can jointly be located on the vehicle body.

Finally, at least one common output power supply connection or one output terminal can be provided, at which the desired output supply voltage (KL 30_1/2) can be provided in operation. The brake control unit and/or another load, for example, actuators of a wheel brake, can be connected to the output supply voltage, for example. Accordingly, the supply voltage of the brake control unit can be produced via the output power supply connection.

The circuit arrangement may be designed to switch the output supply voltage depending on the available supply voltage of the two vehicle electrical systems. Accordingly, the two separate vehicle electrical systems of the motor vehicle can be brought together by the circuit arrangement.

The circuit arrangement may comprise functions for this purpose which are designed to recognize whether malfunctions of a part of the external vehicle electrical system exist or whether, for example, a failure of a vehicle electrical system exists. Accordingly, a switch or changeover can then be performed so that the output supply voltage can be provided at the output power supply connection even in case of fault by corresponding switching to the functioning vehicle electrical system.

The switching of the input terminals can therefore be implemented cost-effectively on a single printed circuit board. According to an embodiment, the current paths can be secured against failure, for example, by switching to the other available supply voltage, and/or against short circuit within the circuit arrangement. Faults recognized in one of the vehicle electrical systems can be combined here by an adapted control so as not to overload individual terminals. The latency times for switching can be reduced to a minimum here, which further reduces the probability of failure and further increases the availability and therefore the operational reliability of the brake control unit.

In one refinement, the operating state of the wheel brakes can moreover be transmitted directly to a higher-order vehicle control system in conjunction with the possible or available supply voltage.

According to one embodiment, the printed circuit board can comprise a polarity reversal protection for both vehicle electrical systems. For this purpose, for example, a module having a polarity reversal protection circuit can be integrated in each power supply path.

The polarity reversal protection may be implemented by two separate low-resistance semiconductor switches or transistors inversely connected in series, wherein, for example, MOSFET transistors can be used. In such a circuit, the gate voltage can be regulated to simulate the function of a diode. This arrangement can ensure that the voltage difference between source electrode and drain electrode corresponds to almost 0 V, for example a target value of 50 mV, when the current flows in the direction of the load (forward current), and that the transistor is switched off when the current flows in the direction of the supply source (reverse current). An integrated controller or an ideal diode controller, for example, an IC, can be provided for actuating the transistors.

A lower power loss and therefore less heating of the transistor than a classic diode in normal operation can be enabled using this arrangement. With such a polarity reversal protection circuit, the second transistor may be used as a switch, using which the current flow can be switched off in the reverse direction.

If the two transistors are arranged “back to back” in series, a disconnecting switch is present in both current flow directions. In the event of a fault of one of the two external vehicle electrical systems, it can thereby be disconnected, so that no further effects on the switched-off vehicle electrical system take place.

The polarity reversal protection circuit can have a signal input for this purpose, via which this module can be actuated, for example switched. The polarity reversal protection circuit can be connected for this purpose, for example, to a control module (“MCU”=“microcontroller unit”).

The control module can be integrated according to one embodiment into the brake control unit (“ECU”=“electronic control unit”).

According to one embodiment, the printed circuit board can furthermore comprise a voltage monitoring function for both vehicle electrical systems. In this way, a change of the voltage in each of the two vehicle electrical systems can be monitored. For this purpose, a module for voltage monitoring can be provided between the respective power supply connections of first type and second type. It is therefore possible to monitor the two vehicle electrical system voltages for faulty states or malfunctions. These can comprise, for example, the disappearance or collapse of the vehicle electrical system voltage, a short-circuit of the system to ground, overvoltage and undervoltage, impermissibly high ripple overlaid on the system voltage, or further faults.

The module for voltage monitoring can furthermore have a signal output, via which the voltage measured value can be output or transmitted. The module for voltage monitoring can be connected for signaling to the control module for this purpose, for example.

According to one refinement, the module for voltage monitoring can also comprise active components, such as an operational amplifier. A corresponding input can be provided for this purpose for the voltage supply.

According to another refinement, the feed of the respective KL30 voltage, thus that of the power supply connections of the first type (KL 30_1, KL 30_2), to this function block or to the respective module for voltage monitoring can also be made switchable. In this way, the standby current consumption can be reduced, for example, in a parking position of the motor vehicle.

According to a further embodiment, a module for current monitoring, which is designed to measure the current, can be provided in each of the current paths between the power supply connection and the reference potential. The module for current monitoring can also have a signal output, via which the current measured value can be output or transmitted. The module for current monitoring can be connected to the control module for this purpose, for example. Using this arrangement for measuring the current in the respective vehicle electrical system path, the operating current can be monitored for observing defined limits.

According to one refinement, the module for current monitoring can have a signal input, via which the module can be actuated, for example switched, in order to reduce the standby current consumption, for example.

The two outputs of the polarity reversal protection circuit may be brought together by an OR connection in a connection node. The supply voltage of the circuit arrangement may be provided at this connection node, for example, to supply the control module and/or the brake control unit.

The common output supply voltage (KL 30_1/2) can therefore follow the higher of the two input voltages (KL 30_1, KL 30_2), and the respective other current path can be switched off.

The supply may take place on the other vehicle electrical system in the event of a failure or a vehicle electrical system which is not functioning properly, but return feed from the functioning vehicle electrical system into the respective other one is avoided or prevented here in order to avoid possible repercussions. For this purpose, the respective second switches of the polarity reversal protection circuit can be switched accordingly.

According to one refinement, it is provided that the two power supply connections of the second type (KL 31_1, KL 31_2) are provided with a circuit arrangement. In other words, according to this refinement, it can be provided that the circuit arrangement is additionally or alternatively also provided for the negative path. This enables the negative path to also be made disconnectable.

Further details are clear from the description of the illustrated exemplary embodiments and the attached claims.

### BRIEF DESCRIPTION OF THE DRAWINGS

In the drawings:

FIG. 1 shows an exemplary embodiment of a circuit arrangement for a brake control unit,

FIG. 2 shows an exemplary embodiment of an OR link, and

FIG. 3 shows a further exemplary embodiment of a circuit arrangement in the negative path.

### DETAILED DESCRIPTION

In the following detailed description of the embodiments, for the sake of clarity, the same reference signs designate substantially identical parts in or on these embodiments. For reasons of clarity, only those elements of the circuit arrangement of the braking device which are relevant for the embodiment of the approach are illustrated.

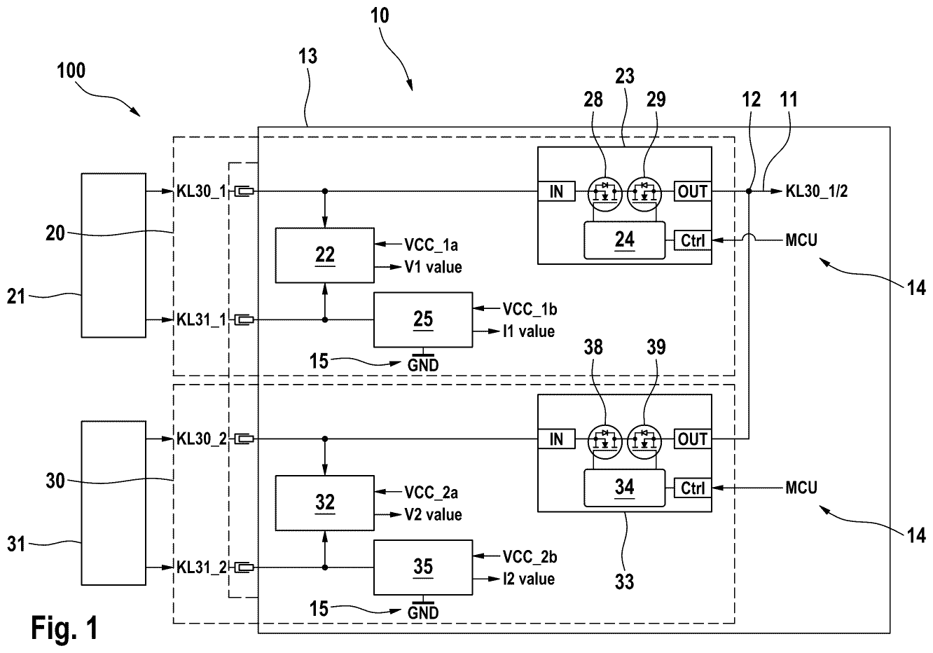

FIG. 1 shows an exemplary embodiment of a circuit arrangement 10. Solely for illustration, the circuit arrangement 10 is shown having a printed circuit board 13, which is in turn part of a brake control unit 100, in a detail view.

Only part of the circuit arrangement 10 is shown in the illustration shown. In other words, only some components and parts or functions are shown on the printed circuit board 13 shown in detail; further modules, such as the control module (“MCU”) or modules for actuating actuators, are not shown. The brake control unit 100 is configured for operating a motor vehicle brake of a motor vehicle.

The circuit arrangement 10 comprises
at least one printed circuit board 13 having the electronic circuit arrangement 10,
at least one first set of electrical power supply connections at least of a first type (KL 30_1) and second type (KL 31_1), which are associated with a first vehicle electrical system 21 and form a first power supply path 20,
at least one second set of electrical power supply connections at least of a first type (KL 30_2) and second type (KL 31_2), which are associated with a second vehicle electrical system 31 and form a second power supply path 30,
at least one connection for a reference potential 15, which is associated with the first power supply path 20, and
at least one connection for a reference potential 15, which is associated with the second power supply path 30,
wherein a polarity reversal protection circuit 23, 33 is provided for each power supply path 20, 30, and
wherein the outputs of the polarity reversal protection circuit 23, 33 are brought together at a connection node 12 and form a common output power supply connection 11, at which a supply voltage (KL 30_1/2) can be provided in operation.

For the embodiments, it is presumed that a redundant vehicle electrical system is provided by the motor vehicle. This is understood to mean that two separate vehicle electrical systems are available in the vehicle.

The embodiments provide connecting these two vehicle electrical systems directly to the printed circuit board 13 of the brake control unit 100. All required functionalities for the voltage supply of the brake control unit 100 and the associated components and parts are concentrated on this printed circuit board 13 here.

The functionality for the voltage supply is designed here such that malfunctions of one of the vehicle electrical systems of the motor vehicle or even a failure of a part of the vehicle electrical system or an entire vehicle electrical system can be recognized, whereupon switching to the remaining functioning power supply of the fault-free vehicle electrical system takes place. The switch is carried out by corresponding functions, which are implemented by the circuit arrangement 10.

The printed circuit board 13 of the exemplary embodiment shown comprises a first set of electric power supply connections at least of a first type (KL 30_1) and second type (KL 31_1), which are associated with the first vehicle electrical system, and a second set of electrical power supply connections at least of a first type (KL 30_2) and second type (KL 31_2), which are associated with the second vehicle electrical system. These power supply connections are led outward, so that the printed circuit board enables connection options for direct connections to the two vehicle electrical systems of the motor vehicle. These power supply connections accordingly represent the input terminals.

Furthermore, connections for the reference potential (“GND”) are provided, which are respectively assigned to the first and the second vehicle electrical system or the first or second power supply path 20, 30. The two power supply connections of the second type (KL 31_1, KL 31_2) or the negative terminals are connected and are jointly at the vehicle body reference potential 15 in the exemplary embodiment.

Finally, a common output power supply connection 11 or an output terminal is provided, at which the desired output supply voltage (KL 30_1/2) can be provided in operation.

Accordingly, the supply voltage for the brake control unit 100, for example, is provided via the output power supply connection 11.

The circuit arrangement 13 is designed to switch the output supply voltage depending on the available supply voltage of the two vehicle electrical systems. For this purpose, the circuit arrangement 13 comprises functions which are designed to recognize whether malfunctions of a part of the external vehicle electrical system or, for example, a failure of a part of a vehicle electrical system exist. A switch is performed accordingly, so that the output supply voltage can also be provided at the output power supply connection 11 in case of fault due to the corresponding switching to the functioning vehicle electrical system.

The circuit arrangement 13 enables the current paths to be secured against failure within the circuit arrangement, for example, by switching to the other available supply voltage, and/or to be secured against short circuit.

The circuit arrangement 13 offers a polarity reversal protection for both vehicle electrical systems in the example. For this purpose, a module having a polarity reversal protection circuit 23, 33 is provided in each power supply path 20, 30. The polarity reversal protection is implemented here in each case by two separate transistors 28, 29 connected inversely in series in the first power supply path 20 and transistors 38, 39 in the second power supply path 30, wherein FET or MOSFET transistors, which are suitable, are used in the exemplary embodiment shown. An ideal diode controller 24, 34 is connected in parallel thereto in each case.

With such a polarity reversal protection circuit 23, 33, the respective second transistor 29, 39 can be used as a switch, using which the current flow back into the associated vehicle electrical system can be switched off. If the first transistor 28, 38 in the current flow is arranged “back to back” in series for this purpose in each case, a disconnecting switch is present in both current flow directions.

In other words, the respective first transistors 28, 38 provide the actual polarity reversal protection. The respective second transistors 29, 39 operate as switches, using which the current flow from the input (“IN”) to the output (“OUT”) can be switched off (reverse current).

The polarity reversal protection circuit 23, 33 in the exemplary embodiment is furthermore designed having a signal input (“Ctrl”), via which the transistors 28, 29, 38, 39 can be actuated or switched. The polarity reversal protection circuit 23, 33 is connected for this purpose to a control module 14.

According to the embodiment shown, the printed circuit board 13 furthermore comprises a voltage monitoring function for each of the two vehicle electrical systems 21, 31. In this way, a change of the voltage in each of the two vehicle electrical systems 21, 31 can be recognized. For this purpose, a module for voltage monitoring 22, 32 is provided between the respective power supply connections of the first type and second type. It is therefore possible to monitor the two vehicle electrical system voltages for faulty states or malfunctions.

The modules for voltage monitoring 22, 32 furthermore have a signal output in the exemplary embodiment, via which the voltage measured value (“V1 value”, “V2 value”) can be output or transmitted. The module for voltage monitoring 22, 32 is connected for signaling to the control module 14 for this purpose.

The module for voltage monitoring 22, 32 can furthermore comprise active components, for example, an operational amplifier. A corresponding input (“VCC_1a”, “VCC_2a”) can be provided for the voltage supply for this purpose.

According to the embodiment shown, the feed of the respective KL30 voltage, thus the power supply connections of the first type (KL 30_1, KL 30_2), to this function block or to the respective module for voltage monitoring is designed as switchable.

According to the embodiment shown, the printed circuit board 13 furthermore comprises a module for current monitoring 25, 35, which is designed to measure the current, in each of the current paths between the power supply connection and the reference potential 15. The module for current monitoring 25, 35 has a signal output in the design shown, via which the current measured value (“I1 value”, “I2 value”) can be output or transmitted. The module for current monitoring 25, 35 is connected to the control module 14 for this purpose. Using this arrangement for measuring the current in the respective vehicle electrical system path, the operating current can be monitored for observing defined limits.

According to the embodiment shown, the module for current monitoring has a signal input, via which the module can be actuated, for example switched. The module for current monitoring is also connected to the control module 14 for this purpose.

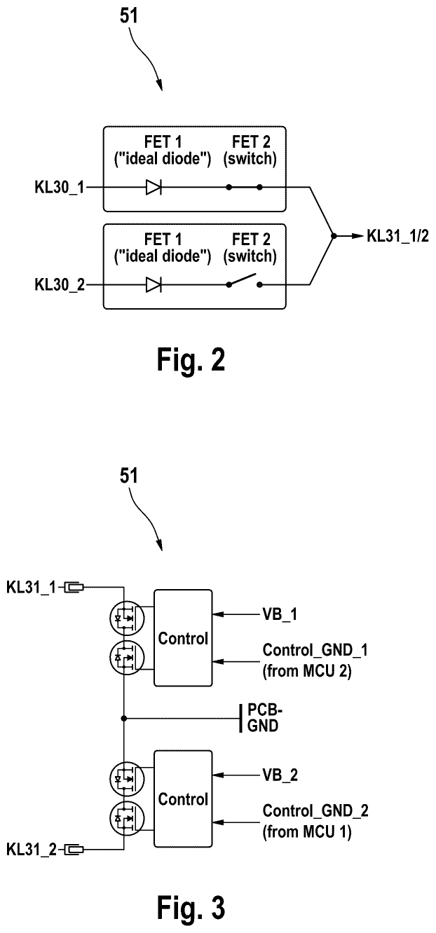

The two outputs of the polarity reversal protection circuit 23, 33 are brought together by an OR connection in a connection node 12. The common output supply voltage (KL 30_1/2) can therefore follow the higher of the two input voltages (KL 30_1, KL 30_2), and the respective other current path can be switched off. FIG. 2 shows an exemplary embodiment of a circuit arrangement 50 for such an OR connection.

According to a refinement, it is provided that the circuit arrangement is also provided for the negative path. This enables the negative path to also be made disconnectable. FIG. 3 shows a further exemplary embodiment for such a circuit arrangement 51 for this purpose.

1. A brake control unit for operating a motor vehicle brake of a motor vehicle, comprising:
at least one printed circuit board having an electronic circuit arrangement;
at least one first set of electrical power supply connections at least of a first type and second type, which are associated with a first vehicle electrical system and form a first power supply path;
at least one second set of electrical power supply connections at least of a first type and second type, which are associated with a second vehicle electrical system and form a second power supply path;
at least one connection for a reference potential, which is associated with the first power supply path;
at least one connection for a reference potential, which is associated with the second power supply path;
a polarity reversal protection circuit for each power supply path, and
a common output power supply connection at which a supply voltage can be provided in operation, wherein the common output power supply connection is formed from outputs of the polarity reversal protection circuit for each power supply path brought together at a connection node.

2. The brake control unit as claimed in claim 1, wherein each polarity reversal protection circuit comprises two transistors connected inversely in series.

3. The brake control unit as claimed in claim 2, wherein the transistors are MOSFET transistors.

4. The brake control unit as claimed in claim 2, wherein an ideal diode controller is connected in parallel to the transistors in each case.

5. The brake control unit as claimed claim 1, wherein the polarity reversal protection circuit has a signal input for switching.

6. The brake control unit as claimed in claim 1, wherein each power supply path comprises a module for voltage monitoring to measure in each case the voltage in a power supply path between the power supply connections of the first type and second type.

7. The brake control unit as claimed in claim 6, wherein the modules for voltage monitoring each have at least one signal output, via which a voltage measured value can be provided.

8. The brake control unit as claimed in claim 1, wherein the two power supply connections of the second type are each connected to a reference potential.

9. The brake control unit as claimed in claim 8, wherein a module for current measurement is provided in each of the current paths between the power supply connection of the second type and the reference potential.

10. The brake control unit as claimed in claim 9, wherein the modules for current measurement each have a signal output, via which a current measured value can be provided.

11. The brake control unit as claimed in claim 9, wherein at least one of the modules for current measurement and the modules for voltage monitoring are connected for signaling to the control module.

12. The brake control unit as claimed claim 1, wherein the first and the second power supply path have an identically designed circuit arrangement.

13. The brake control unit as claimed in claim 1, wherein the associated circuit arrangement is arranged on a single printed circuit board of the brake control unit.

14. A method for operating a brake control unit comprising:
at least one printed circuit board having an electronic circuit arrangement;
providing at least one first set of electrical power supply connections at least of a first type and second type, which are associated with a first vehicle electrical system and form a first power supply path, wherein at least one connection for a reference potential is associated with the first power supply path;
providing at least one second set of electrical power supply connections at least of a first type and second type, which are associated with a second vehicle electrical system and form a second power supply path, wherein at least one connection for a reference potential is associated with the second power supply path;
providing a polarity reversal protection circuit for each power supply path; and
switching of an output supply voltage at an output power supply connection, formed from outputs of the polarity reversal protection circuit for each power supply path brought together at a connection node, wherein the switching depends on the supply voltage available by way of at least one of first and second vehicle electrical system.
